(19) United States
(12) Patent Application Publication
(10) Pub. No.: US 2007/0102373 A1
(43) Pub. Date: May 10, 2007

(54) Apparatus for separating suspensions

(76) Inventor: Hans Larsson, Vasterhaninge (SE)

Correspondence Address: YOUNG & THOMPSON, 745 SOUTH 23RD STREET, 2ND FLOOR, ARLINGTON, VA, 22202, US

(21) Appl. No.: 10/578,881

(22) PCT Filed: Nov. 12, 2003
(86) PCT No.: PCT/SE03/01746

§ 371 Date: Jul. 10, 2006

(51) Int. Cl. C02F 1/38

(52) U.S. Cl. 210/781

(57) ABSTRACT

An apparatus for separating a suspension into a fine fraction and a coarse fraction of the suspension containing solid particles, comprises a rotatable filter disc (5) having a wall (6) of filtering material. During rotation of the filter disc the fine fraction passes through the wall of filtering material, while a mat of the coarse fraction of the suspension is deposited on the wall of filtering material. A mat detachment device (13) includes liquid jet nozzles (14) adapted to spray liquid jets that detach the mat of coarse fraction. The detachment device also includes air jet nozzles (15) adapted to spray air jets against the wall of filter material, so that the air jets participate in the detachment of the mat of coarse fraction and reduce the liquid dilution of the detached mat of coarse fraction.

The present invention relates to an apparatus for separating a suspension into a fine fraction and a coarse fraction of the suspension containing solid particles, comprising a filter rotor, which is rotatable about a horizontal axis, at least one filter disc, which is attached to the filter rotor and has a wall of filtering material, and supply means for supplying the suspension to be separated to the filter disc, so that during rotation of the filter disc the fine fraction of the suspension passes through the wall of filtering material, while a mat of the coarse fraction of the suspension is deposited on the wall of filtering material. A detachment device for detaching the mat of coarse fraction from the wall of filtering material is provided, wherein the detachment device includes at least one liquid jet nozzle adapted to spray a liquid jet against the wall of filtering material.

In a specific type of this separation apparatus, the detachment device is arranged to spray water jets against the side of the filtering material (usually filter cloth) which is opposite the side on which the mat of coarse fraction is deposited. The detached mat and part of the sprayed water drop into a trough from which the resulted mixture of mat and water is discharged from the apparatus.

The specific type of separation apparatus described above is used within the pulp and paper making industry for dewatering fibre suspensions. However, when dewatering fibre suspensions by this type of separation apparatus it is not possible to obtain a fibre concentration of the discharged coarse fraction that exceeds about 1.5% in weight. Typically the fibre concentration obtainable is in the range of 0.2-5%. This low fibre concentration often is very unfavourable for the fibre pulp processing system, in which the apparatus is used.

The object of the present invention is to provide an improved apparatus of the type discussed above, which is capable of producing a substantially higher solid particles concentration of the coarse fraction.

This object is obtained by an apparatus of the kind presented initially characterised in that the detachment device also includes at least one air jet nozzle adapted to spray an air jet against the wall of filtering material, so that the air jet participates in the detachment of the mat of coarse fraction and reduces the liquid dilution of the detached mat of coarse fraction. The air jet nozzle may be used to initially remove a portion of the mat from the filtering material, whereas the liquid jet nozzle may be used to detach residual mat fragments from the filtering material. The flow of liquid sprayed by the liquid jet nozzle may be adjustable, so that no more liquid than is necessary for achieving detachment of residual mat fragments is supplied. Since the small amount of liquid sprayed by the liquid jet nozzle does not dilute the detached mat of coarse fraction so much the obtained solid particles concentration of the discharged coarse fraction of the suspension can be significantly higher than before. As a result, substantial economical savings can be achieved when using the improved apparatus according to the present invention.

Although the detachment device may comprise only one air jet nozzle and only one liquid jet nozzle, in practice the detachment device should comprise a plurality of liquid jet nozzles and a plurality of air jet nozzles.

In a preferred embodiment of the invention, the detachment device is adapted to adjust the relationship between the liquid flow supplied by the liquid jet nozzles and the air flow supplied by the air jet nozzles, in order to provide a desired particle concentration of the detached mat of coarse fraction. To this end, the detachment device may be adapted to close an optional number of the liquid jet nozzles and/or an optional number of the air jet nozzles. Also, The flow of liquid sprayed by the individual liquid jet nozzles may be adjustable to affect the particle concentration of the detached mat of coarse fraction.

The apparatus may include a sensor that continuously senses the particle concentration of the coarse fraction being discharged from the apparatus, and a control unit that controls the number of closed air jet nozzles and/or the number of closed liquid jet nozzles in response to signals from the sensor, so that the desired solid concentration is maintained. Such a control of the solid particle concentration is particularly advantageous, because it makes it possible to compensate for occurring fluctuations of the consistency of the suspension supplied to the apparatus.

The air jet nozzles may be disposed in a row extending radially from the rotor axis and the detachment device may be adapted to reduce the air flow sprayed by the air jet nozzles by closing an optional number of the air jet nozzles, preferably counted from the radially innermost air jet nozzle. Also the liquid jet nozzles may be arranged in a row extending radially from the rotor axis. Preferably, the rows of air and liquid jet nozzles are arranged such that the filtering material with the mat of coarse particles deposited thereon first passes the air jet nozzles during rotation of the filter disc, so that a portion of the mat is detached by the action of the air jets, and then passes the liquid let nozzles so that residual mat fragments on the filtering material are detached by the action of the liquid jets.

Generally, each liquid jet nozzle is adapted to spray liquid in an associated liquid zone and each air jet nozzle is adapted to spray air in an associated air zone, wherein the filtering material passes through the liquid and air zones when the filtering material is above the rotor axis during rotation of the filter disc. Thus, the mat is detached from the part of the filtering material that is displaced above the rotor axis. The liquid and air jet nozzles may be adapted to direct the jets of liquid and air against the filter disc such that a portion of the filtering material which is displaced above the rotor axis during rotation of the filter disc and which passes through any one of the air zones also passes through one of the liquid zones.

Preferably, the liquid and air jet nozzles are adapted to direct the jets of liquid and air against the filter disc such that a portion of the filtering material that is above the rotor axis during rotation of the filter disc first passes through any one of the air zones and then passes through one of the liquid zones. Alternatively, however, the liquid and air jet nozzles may be adapted to direct the jets of liquid and air against the filter disc such that a portion of the filtering material that is above the rotor axis during rotation of the filter disc first passes through any one of the liquid zones and then passes through one of the air zones.

The invention is described in more detail in the following with reference to the accompanying drawings, in which

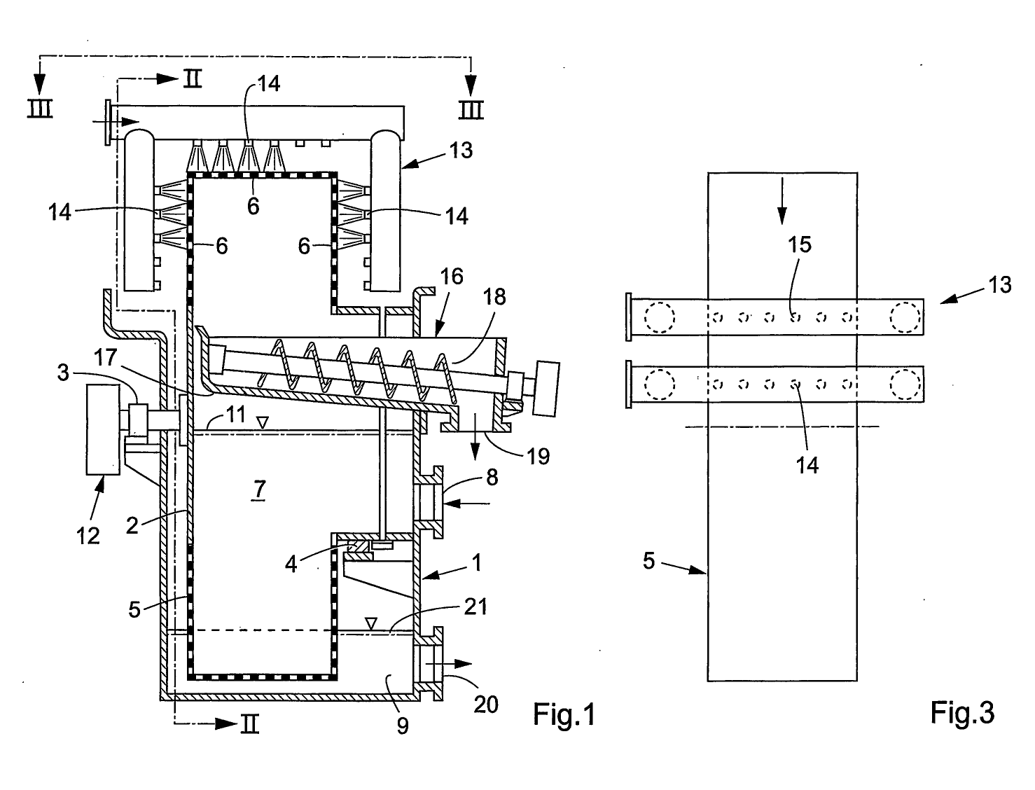

FIG. 1 is a longitudinal cross-sectional view of an embodiment of the present invention,

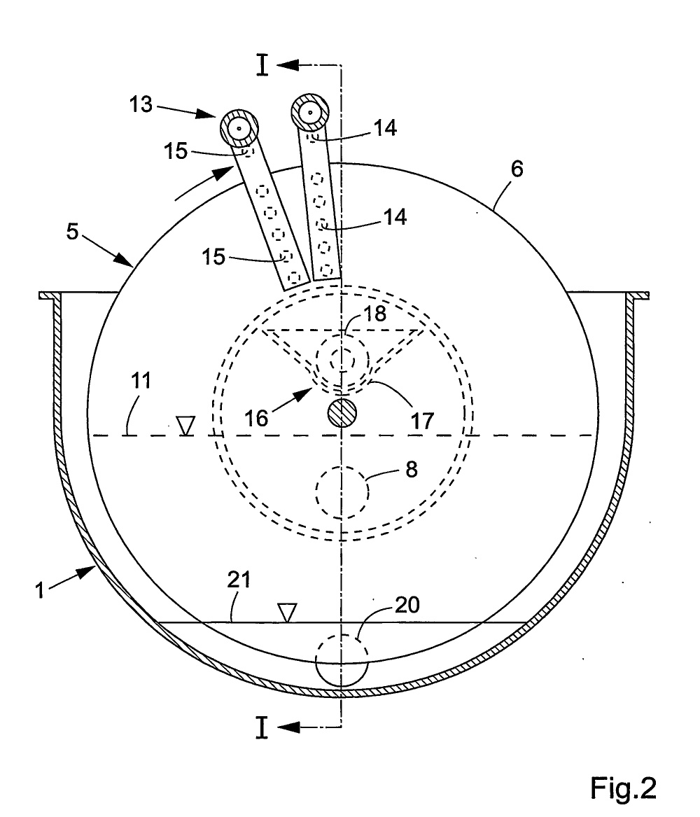

FIG. 2 is a view of a cross-section along the line II-II in FIG. 1, and

FIG. 3 is a partial top view of the embodiment shown in FIG. 1.

FIG. 1 shows an apparatus according to the present invention for separating a suspension into a fine fraction of the suspension and a coarse fraction of the suspension containing solid particles. The apparatus comprises a housing 1, a rotor 2 journalled on bearings 3 and 4 provided on the housing 1 to rotate about a horizontal axis, and a hollow vertical filter disc 5 attached to the rotor 2. The filter disc 5 has walls 6 of filtering material, such as cloth, that define a chamber 7 for receiving the suspension to be separated via an inlet member 8 provided on the housing 1. The housing 1 forms a filtrate chamber 9 for receiving the fine fraction that passes from the chamber 7 through the filtering walls 6. There is an outlet member 10 on the housing for discharging the fine fraction from the filtrate chamber 9.

During operation of the apparatus the suspension is pumped through the inlet member 8, so that the suspension fills about half the chamber 7 to a level 11 indicated in FIG. 1. A drive motor 12 rotates the rotor 2 and the filter disc 5, whereby the filtering material 6 is cyclically displaced in the suspension and above the suspension. Hydrostatic pressure difference across the filtering material within the suspension causes a fine fraction to pass through the filtering material while a mat of a coarse fraction deposits on the filtering material inside the chamber 7.

There is a detachment device 13 for detaching the mat or coarse fraction from the wall of filtering material being displaced above the horizontal axis of the rotor 2. The detachment device 13 includes liquid jet nozzles 14 adapted to spray liquid jets against the external sides of the walls 6 of filtering material and air jet nozzles 15 adapted to spray air jets against the external sides of the walls 6 of filtering material. In the embodiment shown in the Figures, there are also air and liquid jet nozzles arranged to spray against a peripheral cylindrical wall of filtering material. However, alternatively the filter disc 5 may be designed with filtering material only on the vertical sides of the filter disc 5 or only on the cylindrical wall of the filter disc 5.

With reference to FIG. 2, the air jet nozzles 15 are arranged in a radial row to blow off a portion of the mat deposited on the filtering material, as the filtering material passes the air jets from the air jet nozzles 15 during rotation of the filter disc 5. The liquid jet nozzles 14 are also arranged in a radial row, which is situated after the row of air jet nozzles 15, as seen in the rotational direction of the filter disc 5. The liquid jet nozzles 14 in the row of nozzles 14 spray liquid, usually water, against the filtering material to detach residual mat fragments from the filtering material.

There is a discharge device 16 for discharging the detached mat of coarse fraction from the apparatus. The discharge device 16 includes a chute 17 for receiving mat pieces and liquid dropping from the internal sides of the filtering material, and a conveyer screw 18 for conveying the received mixture of mat pieces and liquid to a coarse fraction outlet 19 on the chute 17.

The fine fraction of the suspension is collected in the filtrate chamber 9 and is discharged through a filtrate outlet 20 on the housing 1. The apparatus is operated so that the surface level 21 of the fine fraction in the chamber 9 is well below the surface level 11 of the suspension in the chamber 7, to maintain a sufficient hydrostatic pressure difference across the filter material submerged in the suspension.

A desired solid particle concentration of the discharged coarse fraction can be achieved by closing one or more air jet nozzles 15 and/or closing one or more liquid jet nozzles 14. Besides closing one or more nozzles, the flow of liquid sprayed by the individual liquid jet nozzles can be adjusted to obtain the desired concentration. When one or more air nozzles 15 that are directed towards the vertical sides of the filtering material are to be closed, preferably the radially innermost nozzles should be chosen. One reason for doing so is that the innermost nozzles are less effective than the radially outermost nozzles, because of the relatively low velocity of the filtering material that passes the innermost nozzles during rotation of the filter disc. Another reason for doing so is when the apparatus is equipped with a relatively narrow filter disc, which might give rise to the problem that relatively large and dry mat pieces detached by the upper air jet nozzles tend to get stuck in the hollow narrow disc. Thus, with lower air nozzles closed the water sprayed from the liquid jet nozzles aids at carrying away such large mat pieces downwardly to the chute 17 without being hindered by any lower dry mat pieces.

Although the embodiment of the invention described above relates to the type of apparatus in which the suspension is separated by being forced through the filtering material in the direction from inside the hollow disc to the outside thereof, the invention is also applicable to the common type of separation apparatus in which the suspension is forced through the filtering material in the direction from outside the hollow filter disc to the inside thereof.

1. An apparatus for separating a suspension into a fine fraction and a coarse fraction of the suspension containing solid particles, comprising a filter rotor (2), which is rotatable about a horizontal axis, at least one filter disc (5), which is attached to the filter rotor and has a wall (6) of filtering material, supply means (8) for supplying the suspension to be separated to the filter disc, so that during rotation of the filter disc the fine fraction of the suspension passes through the wall of filtering material, while a mat of the coarse fraction of the suspension is deposited on the wall of filtering material, and a detachment device (13) for detaching the mat of coarse fraction from the wall of filtering material, the detachment device including at least one liquid jet nozzle (14) adapted to spray a liquid jet against the wall of filtering material, characterised in that the detachment device (13) also includes at least one air jet nozzle (15) adapted to spray an air jet against the wall (6) of filtering material, so that the air jet participates in the detachment of the mat of coarse fraction and reduces the liquid dilution of the detached mat of coarse fraction.

2. An apparatus according to claim 1, wherein the detachment device (13) is adapted to adjust the relationship between the liquid flow supplied by the liquid jet nozzle (14) and the air flow supplied by the air jet nozzle (15), in order to provide a desired particle concentration of the detached mat of coarse fraction.

3. An apparatus according to claim 1, wherein the detachment device (13) comprises a plurality of liquid jet nozzles (14) and a plurality of air jet nozzles (15).

4. An apparatus according to claim 3, wherein the detachment device (13) is adapted to adjust the relationship between the liquid flow supplied by the liquid jet nozzles (14) and the air flow supplied by the air jet nozzles (15), in order to provide a desired particle concentration of the detached mat of coarse fraction.

5. An apparatus according to claim 4, wherein the detachment device (13) is adapted to close an optional number of the liquid jet nozzles (14) and/or an optional number of the air jet nozzles (15), to adjust the relationship between the liquid flow sprayed by the liquid jet nozzles and the air flow sprayed by the air jet nozzles.

6. An apparatus according to claim 4, wherein the air jet nozzles (15) are disposed in a row extending radially from the rotor axis and the detachment device (13) is adapted to reduce the air flow sprayed by the air jet nozzles by closing an optional number of the air jet nozzles.

7. An apparatus according to claim 6, wherein the detachment device (13) is adapted to reduce the air flow by closing an optional number of the air jet nozzles (15) counted from the radially innermost air jet nozzle.

8. An apparatus according to claim 4, wherein the detachment device (13) is adapted to adjust the liquid flow sprayed by each liquid jet nozzle.

9. An apparatus according to claim 1, wherein each liquid jet nozzle (14) is adapted to spray liquid in an associated liquid zone and each air jet nozzle (15) is adapted to spray air in an associated air zone, the filtering material passing through the liquid and air zones when the filtering material is above the rotor axis during rotation or the filter disc (5).

10. An apparatus according to claim 9, wherein the liquid and air jet nozzles (14,15) are adapted to direct the jets of liquid and air against the filter disc (5) such that a portion of the filtering material which is above the rotor axis during rotation of the filter disc and which passes through any one of the air zones also passes through one of the liquid zones.

11. An apparatus according to claim 9, wherein the liquid and air jet nozzles (14,15) are adapted to direct the jets of liquid and air against the filter disc (5) such that a portion of the filtering material that is above the rotor axis during rotation of the filter disc first passes through any one of the air zones and then passes through one of the liquid zones.

12. An apparatus according to claim 9, wherein the liquid and air jet nozzles (14,15) are adapted to direct the jets of liquid and air against the filter disc such that a portion of the filtering material that is above the rotor axis during rotation of the filter disc (5) first passes through any one of the liquid zones and then passes through one of the air zones.

13. An apparatus according to claim 3, wherein each liquid jet nozzle (14) is adapted to spray liquid in an associated liquid zone and each air jet nozzle (15) is adapted to spray air in an associated air zone, the filtering material passing through the liquid and air zones when the filtering material is above the rotor axis during rotation or the filter disc (5).

14. An apparatus according to claim 4, wherein each liquid jet nozzle (14) is adapted to spray liquid in an associated liquid zone and each air jet nozzle (15) is adapted to spray air in an associated air zone, the filtering material passing through the liquid and air zones when the filtering material is above the rotor axis during rotation or the filter disc (5).

15. An apparatus according to claim 5, wherein each liquid jet nozzle (14) is adapted to spray liquid in an associated liquid zone and each air jet nozzle (15) is adapted to spray air in an associated air zone, the filtering material passing through the liquid and air zones when the filtering material is above the rotor axis during rotation or the filter disc (5).

16. An apparatus according to claim 6, wherein each liquid jet nozzle (14) is adapted to spray liquid in an associated liquid zone and each air jet nozzle (15) is adapted to spray air in an associated air zone, the filtering material passing through the liquid and air zones when the filtering material is above the rotor axis during rotation or the filter disc (5).

17. An apparatus according to claim 7, wherein each liquid jet nozzle (14) is adapted to spray liquid in an associated liquid zone and each air jet nozzle (15) is adapted to spray air in an associated air zone, the filtering material passing through the liquid and air zones when the filtering material is above the rotor axis during rotation or the filter disc (5).

18. An apparatus according to claim 8, wherein each liquid jet nozzle (14) is adapted to spray liquid in an associated liquid zone and each air jet nozzle (15) is adapted to spray air in an associated air zone, the filtering material passing through the liquid and air zones when the filtering material is above the rotor axis during rotation or the filter disc (5).
